(19) United States
(12) Patent Application Publication
(10) Pub. No.: US 2015/0108837 A1
(43) Pub. Date: Apr. 23, 2015

(54) AUDIO-POWER CONVERTER

(71) Applicant: Sameer Logue, Fort Worth, TX (US)

(72) Inventor: Sameer Cholayil, Fort Worth, TX (US)

(21) Appl. No.: 14/060,619

(22) Filed: Oct. 23, 2013

(51) Int. Cl. H02J 1/10

(52) U.S. Cl. CPC H02J 1/102
USPC 307/24

(57) ABSTRACT

An apparatus and method for converting audio signals to power supply signals that includes a step-up transformer, rectifier, and energy storage device on each channel, and uses information on one channel to control the output voltage sources.

### TECHNICAL FIELD OF THE INVENTION

The present disclosure relates to the use of mobile computers and other electronic to charge and sequence power in their accessories.

### BACKGROUND OF THE INVENTION

Method for powering an accessory device using the audio output ports of devices like Walkman and computers have existed for some time. Though the audio output per channel from the said devices could be of the order of 30 mW to 55 mW per channel, use is limited to accessories that consumes less than about 10 mW considering losses in conversion to higher usable voltage from the 0.15-0.4V peak-to-peak at the audio output.

The electronics industry still seeks a useful approach to audio signal conversion that is not limited to such small power needs.

### SUMMARY OF THE INVENTION

The present disclosure includes an apparatus and method by which the traditional limitations of audio signal conversion are overcome to allow such circuits to provide useful power.

The method here aims to overcome this limitation by accumulating power over time and releasing the stored power in a controlled manner to sections that use higher power.

Software running on the mobile computer device is a critical element of this invention. The software puts out an appropriate frequency audio signal at the output of the audio out of the device to keep the accessory powered or charged as needed in the background.

Optionally, the system detects the presence of an accessory plugged in to prevent audio disturbance from the speaker in the absence of an accessory.

Novel and inobvious aspects of the invention comprise a new approach to control of the audio signal to allow power storage and delivery. Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts.

FIG. 1 shows a block diagram of one embodiment of the invention.

FIG. 2A provides a sample input of the left audio channel used to create maximum power with the invention.

FIG. 2B provides a sample input of the right audio channel used to control the output of the invention.

FIG. 3 shows a detailed circuit diagram of one embodiment of the invention.

FIG. 4 discloses a second embodiment of the invention, employing a different sequencing mechanism.

FIG. 5 discloses a third embodiment of the invention using yet another sequencing mechanism.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

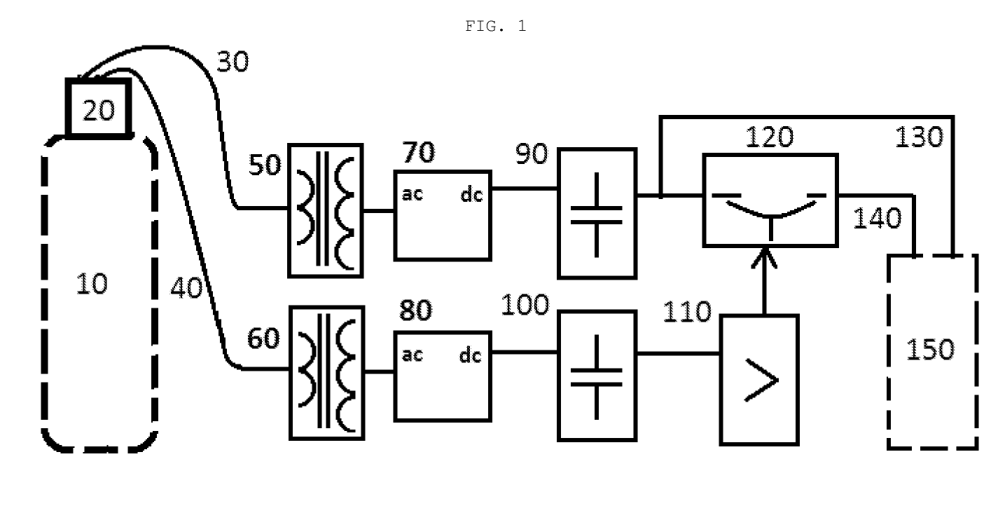

FIG. 1 shows a block diagram of the preferred embodiment of the invention, which comprises the electrical components between the Mobile Computer 10 and the Accessory 150. The whole circuit may be enclosed within an accessory, in that case 150 shows the main part of the accessory other than the power supply.

The Headphone Connector 20 accepts signals from the Mobile Computer, conveyed by an audio out on Left Channel Wire 30 and Right Channel Wire 40.

Left and Right Channel Transformers 50 60 convert the audio signals. Typically these signals do not exceed 0.4V, so they are stepped up by a factor of 10 to 20 in current embodiments.

The stepped up signals from the Left and Right Channel Transformers 50 60 then feed into Left and Right Channel Rectifiers 70 80, respectively, which convert the magnified sinusoidal audio signal into an effective DC power source ranging from 3V to 5V, depending on the components employed in the circuit.

The converted signals leave the Rectifiers 70 80 and feed into Power Storage Element 90 and Signal Storage Element 100. In the current embodiment, capacitors serve as the Power Storage Element 90 and Signal Storage Element 100, but in other applications considered, a battery might be employed for these elements. In many applications, Power Storage Element 90 is ideally a super capacitor with storage capacity with several magnitudes more storage than Signal Storage Element 100. This difference allows the voltage on the Signal Storage Element 100 to change quickly, a desired trait necessary for fast signal change. In comparison, the Power Storage Element 90 has no need to change voltage quickly; its task in the circuit is to store as much power as practicable.

In the current embodiment, the audio signal from the left channel is converted to power in Power Storage Element 90, where it accumulates and becomes ready for use as a stable voltage source. However, the audio signal from the right channel becomes a control signal generated by Signal Storage Element 100, which when energized, acts to release the converted and stored power.

The right channel Power Storage Element 100 feeds into Voltage Comparator 110. When the voltage on the Power Storage Element 100 exceeds a set level, the Comparator 110 triggers the Switch 120 to deliver higher power through connection 140 to the accessory 150.

As FIG. 1 shows, in the embodiment shown, the user-supplied Accessory 150 always has use of the high voltage output of Power Storage Element 90 through Output Connection 130. However, the signal generated through the right channel controls a second output source through Output Connection 140.

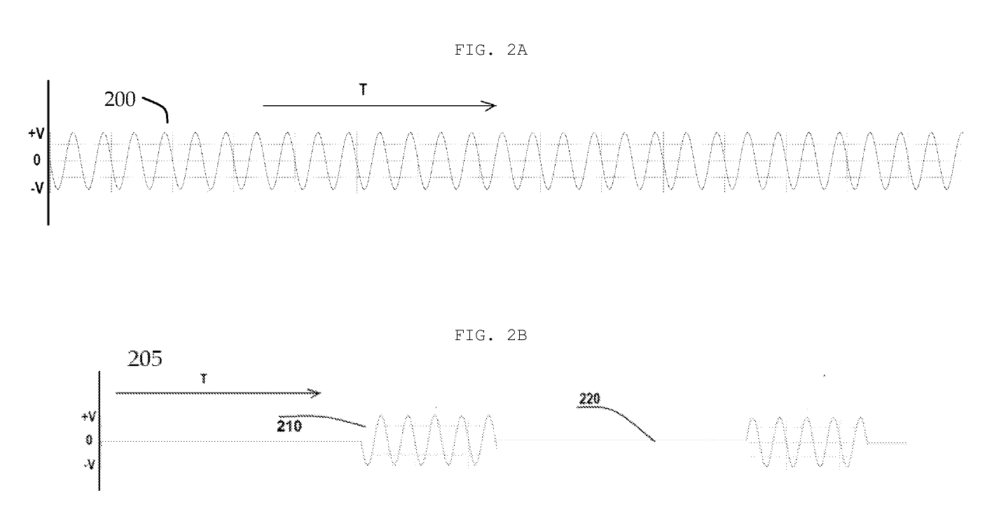

FIG. 2A. shows a sample wavelength Left Power Signal 200 created by the Mobile Computer 10 and sent to the left channel when instructed by software running on it. The waveform is designed to transmit signals with as much power output as possible to charge Storage Element 90.

Operating Signal 210 of FIG. 2B is a control signal, so it does not appear as continuous and unchanging, but is designed to cease and allow the control signal feeding the right channel Power Storage Element 100 to reduce to 0V output, or at least below the trigger voltage on the Comparator, and in this way, control the voltage supply to the Accessory 150, which provides a controlled source to the high power consumption circuits of the Accessory 150 as needed.

In this example embodiment, as shown in FIG. 2B, software on the Mobile Computer 10 causes the Mobile Computer 10 to emit a Right Channel Operating Signal 205 along Right Channel Wire 40, which is applied to the Right Channel Transformer 60, which is typically in one of two states. It begins with a Charging Time 220, a null output for an initial period of time, followed by an Energizing Time 210.

The Charging Time 220 begins as a null signal to allow the Left Channel Power Storage Element 90 to charge to an operating level.

The Charging Time 220 signal is followed by an Energizing Time 210, which charges the Right Channel Power Storage Element 100, and subsequently causes a change of state in the Comparator 110 and Gate 120, and power delivered to the load along Controlled Voltage Output 140. The cycle repeats as directed by the software to allow the power storage elements time to charge and repeat a cycle in which an Accessory 150 can include a high power load.

The minimum duration that the invention must receive from the Mobile Computer 10 on Left Channel Power Signal 200 depends on the size of the Power Storage Element 90 and the power requirement on Output 140. The Right Channel Operating Signal 205 can be used to sequence power to Controlled Voltage Output 140 as needed provided the Power Storage Element 90 has been charged. The invention responds to the instructions to provided to it by the Mobile Computer 10 through the Right Channel Operating Signal 205.

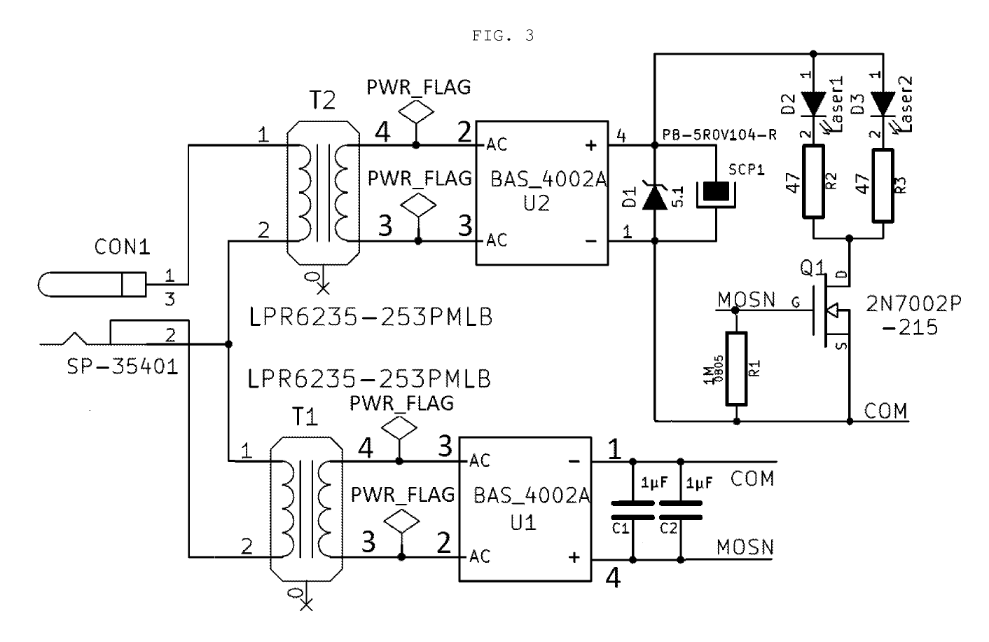

FIG. 3 provides a schematic of one embodiment of the invention. Certain other elements not previously discussed are minor components designed to make the circuit more efficient and reliable, such as the Impedance-Matching Capacitors 51 and Overvoltage Protection Diode 91.

Also in the current embodiment, Left Channel Rectifier is a low leakage Schottky bridge rectifier for efficiency. The rectified DC voltage of this channel is used to charge the Power Storage Element 90, a position currently held by a supercapacitor. Current limiting is done by the winding impedance of the Transformers 50 60. Every knowledgeable electrical engineer is familiar with these and other similar design techniques and are not specific to this invention.

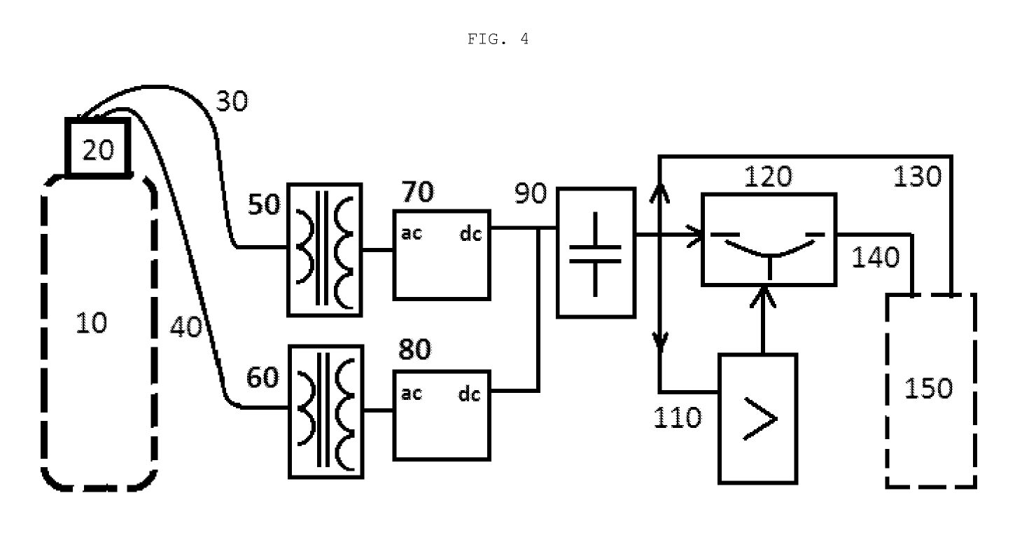

FIG. 4 discloses another embodiment of the invention, similar to that of FIG. 1, except that the Signal Storage Element 100 on the right channel is not included. Both rectifiers feed into the Power Storage Element 90, which allows faster charging of the storage device 90 and more power output as both audio output channels are used to charge the same capacitor. Voltage Comparator 110 now compares the Power Storage Element 90 to an internal reference, and triggers the Gate 120 on that attaining a certain voltage level.

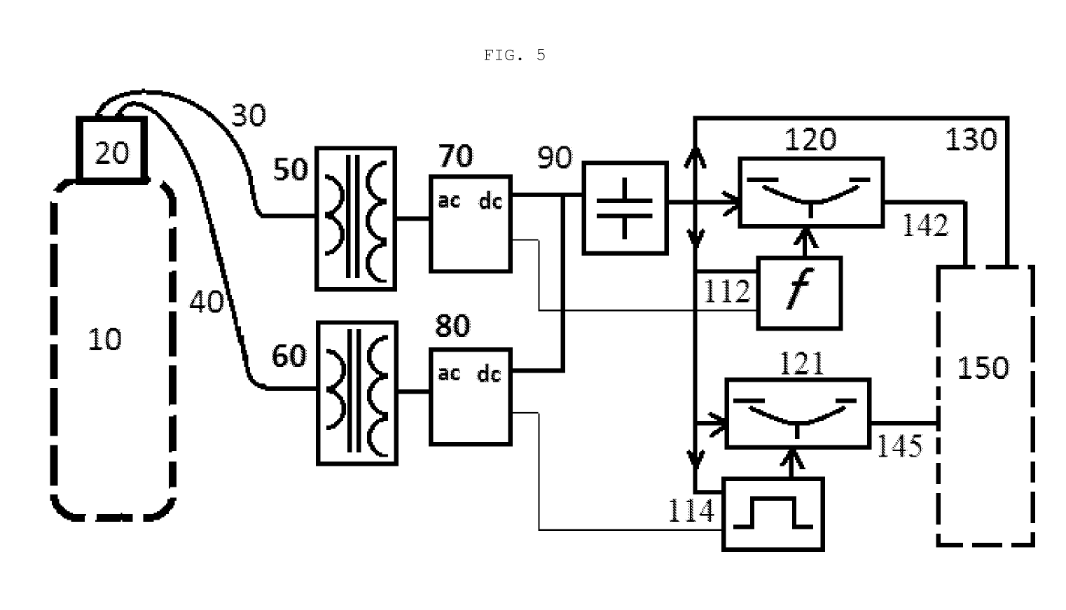

FIG. 5 discloses another embodiment of the invention, similar to the FIG. 4. embodiment, except it has two sequencing mechanisms. This is achieved by removing the Voltage Comparator 110 of FIG. 4 and adding a Frequency Comparator 112 on left audio output channel and a Pulse-Width comparator 114 on the right channel. This allows the outputs 142 and 145 to be sequenced independently. To trigger output 142, the frequency of the charging signal on the left channel is changed by the software running on Mobile Computer 10 to that frequency that causes the Frequency Comparator 112 to trigger Gate 120. To trigger Output 145, the pulse width on the Left Channel 30 is provided by the Mobile Computer 10 to that pulse width relation that causes the Pulse-Width Comparator 114 to trigger Gate 121.

Though the embodiments described herein include a computer control signal of some sort, the invention does not have to require software control. A simplified version of the embodiment without specific voltage control can easily be constructed to take the signals from the Mobile Computer 10, rectify and store it, and just allow the Accessory 150 to draw what it needs for the user's purpose.

It is asserted that any person with skill in the art can determine the electronic components required to build the circuits designed. For example, the Voltage Comparator 110 element could be a MOSFET with a minimum voltage requirement to turn on, and also act as the Gate 120. More specialized circuitry can also be used. The time when the minimum voltage requirement is met is dependent on the Operating Signal 210 generated by the Mobile Computer 10, and storage elements.

All embodiments described herein are presented for purposes of illustration and explanation only. These descriptions of one embodiment are not intended to be limiting to the embodiments described. Those skilled in the relevant art will be able to create other embodiments based on this disclosure and the claims attached with this application.

The user should recognize that the Mobile Device 10 will have software running that provides signals to operate the invention by generating appropriate inputs to each channel.

A legend of referenced components in the drawings included in this system is as follows:

| | | | |
|---|---|---|---|
| 10 | Mobile Computer | 120 | Gate |
| 20 | Headphone Connector | 121 | Gate |
| 30 | Left Channel Wire | 130 | Continuous Voltage Output |
| 40 | Right Channel Wire | 140 | Controlled Voltage Output |
| 50 | Left Channel Transformer | 142 | Frequency Voltage Output |
| 60 | Right Channel Transformer | 150 | Accessory (not part of |
| 70 | Left Channel Rectifier | | the invention) |
| 80 | Right Channel Rectifier | 200 | Left Channel Power Signal |
| 90 | Power Storage Element | 205 | Right Channel Operating |
| 100 | Signal Storage Element | | Signal |
| 110 | Comparator | 210 | Energizing Time |
| 112 | Frequency Comparator | 220 | Charging Time |
| 114 | Pulse-Width Comparator | | |

The inventor claims:

1. A method of converting audio signal outputs to power sources, comprising the steps:
a. feeding one or more electronic audio drive channel signals into step-up transformers;
b. rectifying each channel signal from the step-up transformers;
c. storing the power from each stepped-up and rectified signal to create a power reservoir;
d. releasing the stored power from one or more power reservoirs to one or more loads.

2. The method of claim 1 with additional limitations:
a. feeding one or more electronic audio drive channel signals into step-up transformers;
b. rectifying each channel signal from step-up transformers;
c. storing the power from each stepped-up and rectified signal to create a power reservoir;
d. monitoring one of the power reservoir;
e. releasing the power from at least one voltage sources to one or more loads based on the voltage of the monitored source.

3. The method of claim 2 with additional limitations:
a) feeding one or more electronic audio drive channel signals into step-up transformers;
b) rectifying one or more channel signals from the step-up transformers;
c) storing the power delivered by the rectified signals to create one or more power reservoirs;
d) monitoring the frequency at least one stepped-up audio drive signal before rectification;
e) comparing the monitored frequency to a reference frequency;
f) triggering a gate based on a comparison of the monitored frequency to the reference frequency;
g) energizing one or more outputs powered by the power reservoirs created by the rectified signals based on the triggered gate;

4. The method of claim 1 with additional limitations as follows:
a) feeding one or more electronic audio drive channel signals into step-up transformers;
b) rectifying one or more of the channel signals from the step-up transformers;
c) storing the power delivered by the rectified signals to create one or more voltage sources;
d) monitoring the pulse width of one audio drive signal;
e) comparing the pulse-width to a referenced pulse width;
f) triggering a gate based on a comparison of the monitored frequency to the reference frequency;

5. An apparatus used to convert audio signals from a mobile computer, comprising:
a) a two-channel input jack;
b) two step-up transformers, one for each signal channel coming from the jack;
c) two rectifier circuits that rectify the stepped-up signal channel output;
d) an output jack.

6. An apparatus used to convert audio signals from a mobile computer as in claim 5, additionally including a circuit to compare an incoming signal frequency to a reference, and energize the apparatus's output when the incoming signal to the apparatus meets the user's criteria.

7. An apparatus used to convert audio signals from a mobile computer as in claim 5, additionally including a circuit to compare a pulse width with a referenced pulse, and energize the apparatus's output when the incoming signal to the apparatus meets the user's criteria.
